(19) United States
(12) Patent Application Publication
(10) Pub. No.: US 2007/0016469 A1
(43) Pub. Date: Jan. 18, 2007

(54) On-line advertising system and method

(75) Inventors: Sang Yong Bae, Seoul (KR); Jung Soo Ha, Seoul (KR); Woo Sung Lee, Seoul (KR)

Correspondence Address: BLACKWELL SANDERS PEPER MARTIN LLP, 720 OLIVE STREET, SUITE 2400, ST. LOUIS, MO, 63101, US

(73) Assignee: NHN CORPORATION, Kyunggi-do (KR)

(21) Appl. No.: 10/595,998

(22) PCT Filed: Nov. 24, 2004
(86) PCT No.: PCT/KR04/03043

§ 371 Date: Jun. 14, 2006

(30) Foreign Application Priority Data
Nov. 24, 2003 (KR) 10-2003-0083475

(51) Int. Cl. G06Q 30/00; G07G 1/14

(52) U.S. Cl. 705/14

(57) ABSTRACT

The present invention relates to an on-line advertising system and method which can provide an advertisement related to predetermined content to a user through a wired/wireless communication network along with the content. An on-line advertising system according to the present invention comprises an advertisement database for maintaining advertisement data, a keyword related thereto and a category corresponding thereto; a content database for maintaining a content identifier for identifying content provided to a user terminal through a communication network, and a category related to the content; an advertisement data searching unit for searching the advertisement database for advertisement data corresponding to a category related to the content; an advertisement data selecting unit for selecting advertisement data from the searched advertisement data, based on a predetermined criterion, by using a keyword related to the searched advertisement data; and a display control unit for controlling the adopted advertisement data to be displayed on the user terminal in association with the content.

### TECHNICAL FIELD

The present invention relates to an on-line advertising system and method which can provide a user with an advertisement related to a predetermined content through a wired/wireless communication network, together with the content.

### BACKGROUND ART

FIG. 1 is a drawing illustrating an outline of an on-line advertising system according to the prior art. An advertising system 100 according to the prior art comprises an advertisement server 101 and an advertisement database 102. A client 110 accesses to the advertising system 100 through a communication network. The advertising system 100 provides an advertisement for the client 110 through a predetermined web page.

The advertisement database 102 maintains each advertisement received from an advertiser and a keyword related to the advertisement. The advertisement server 101 detects a keyword for searching an advertisement from content provided on the web page and searches the advertisement database for an advertisement related to the detected keyword. Since there are pluralities of words comprised in the content, it is possible to abstract a word which appears in the content frequently, based on a noun, and to determine the word abstracted like above as a keyword.

The advertisement server 101 provides the client 110 with the advertisement searched like above by disclosing the same on the web page. According to the prior art, since an advertisement related to a keyword contained in the content is provided on the web page, there is an advantage that it is possible to provide a client for the advertisement related to the content disclosed on the web page.

For example, if the content includes a phrase saying ‘because of cold weather, sales of heaters have increased’ and in relation thereto, ‘heaters’, ‘worm electric fans’ or ‘radiator selling companies’ would be advertised on the web page. Therefore, since users who are interested in a content provided on the web page and read the content are provided with advertisements related to the content, it is possible to provide a advertisement targeted by the user.

However, according to the prior art, since keywords are loosely determined based on frequency of words, there are many cases that a story of advertisement selected according to the prior art is a little irrelevant to that of the content. Therefore, there is a problem that the prior art cannot achieve an object thereof (advertisement effect) in an occasion like above.

Moreover, according to the prior art, in case that the web page provides a news content including ‘a murderer left a dead body in the refrigerator’, an advertisement with respect to a site for sales of refrigerators may be displayed on the same web page. At this time, the advertisement may give readers of the web page an uncomfortable image on the refrigerator selling company. However, according to the prior art, there is no way to prevent the problem like above.

### BRIEF DESCRIPTION OF THE DRAWINGS

FIG. 1 is a drawing illustrating an outline of an on-line advertising system according to the prior art.

FIG. 2 is a drawing illustrating a network connection of all advertising system according to one embodiment of the present invention.

FIG. 3 is a block diagram illustrating components of an advertising system according to one embodiment of the present invention.

FIG. 4 is a drawing illustrating one example of data maintained in an advertisement database, in an advertising system according to one embodiment of the present invention.

FIG. 5 is a drawing illustrating one example of data maintained in a content database, in an advertising system according to one embodiment of the present invention.

FIG. 6 is a view illustrating one example of a web page on which advertisement data adopted according to one embodiment of the present invention is displayed.

FIG. 7 is a block diagram illustrating an advertisement data selecting unit according to one embodiment of the present invention.

FIG. 8 is a drawing for describing a method of computing an exposure point related to predetermined advertisement data, in one embodiment of the present invention.

FIG. 9a is a drawing illustrating one example of keywords maintained in a keyword database, similar keywords related thereto and expansion keywords related thereto, in an advertising system according to one embodiment of the present invention.

FIG. 9b is a flowchart for generally describing a process performed by an advertising system according to one embodiment of the present invention.

FIG. 10 is a flowchart illustrating an advertising method according to another embodiment of the present invention.

FIG. 11 is a flowchart more specifically illustrating procedures of maintaining an advertisement database, in another embodiment of the present invention.

FIG. 12 is a view illustrating one example of a user interface enabling an advertiser to select a category using a directory searching method, in another embodiment of the present invention.

FIG. 13 is a flowchart more specifically illustrating procedures of selecting advertisement data using a keyword, in another embodiment of the present invention.

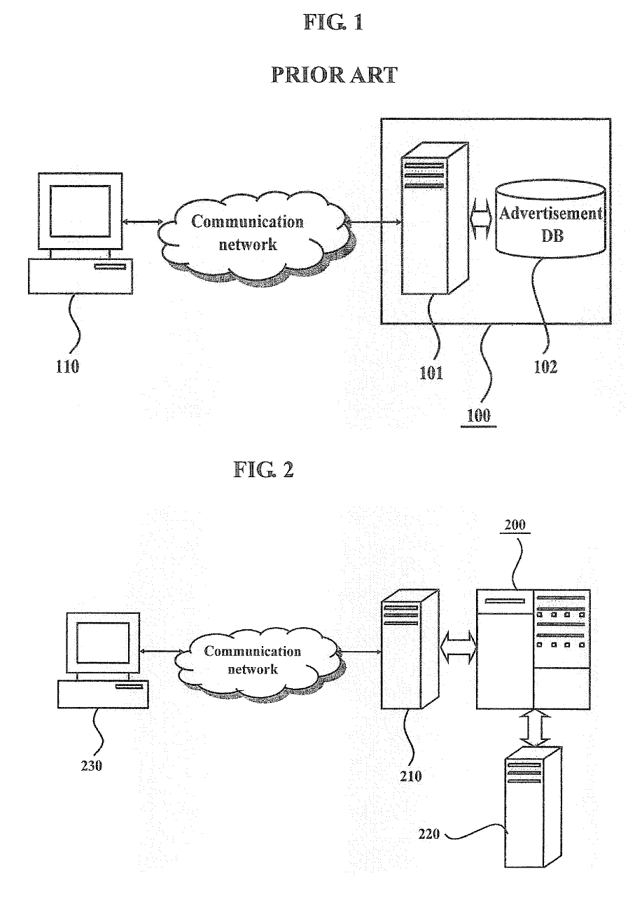

### DISCLOSURE OF THE INVENTION

### Technical Questions

The present invention is conceived to solve the aforementioned problems in the prior art. Thus, an object of the present invention is to provide an on-line advertising system and method which can secure a connection between content and an advertisement provided for users through a wired/wireless communication network, in association with the content.

Furthermore, although the advertisement is highly connected to the content provided for users through a wired/wireless communication network, in case that it is determined that the advertisement is irrelevant based on goods to be sold through the advertisement or a service image, an object of the present invention is to provide an on-line advertising system and method which can prohibit the irrelevant advertisement from being displayed on the web page together with the content.

### TECHNICAL SOLUTIONS

In order to achieve the aforementioned objects and to solve the problems in the prior art, an on-line advertising system according to the present invention comprises an advertisement database for maintaining advertisement data, a keyword related thereto and a category corresponding thereto; a content database for maintaining a content identifier for identifying content provided to a user terminal through a communication network, and a category related to the content; an advertisement data searching unit for searching the advertisement database for advertisement data corresponding to a category related to the content; an advertisement data selecting unit for selecting advertisement data from the searched advertisement data, based on a predetermined criterion, by using a keyword related to the searched advertisement data; and a display control unit for controlling the adopted advertisement data to be displayed on the user terminal in association with the content.

According to one aspect of the present invention, the system further comprises a keyword database for maintaining a keyword and a relevant keyword related thereto; wherein the advertisement data selecting unit comprises a keyword searching module for searching the content for a keyword related to the searched advertisement data and a relevant keyword related to the keyword; an exposure point computing module for inspecting at least one selected from a group consisting of the number of the searched keywords, locations thereof in the content and font styles thereof, and computing a first exposure point related to the advertisement data based on the result of the inspection; inspecting at least one selected from a group consisting of the number of the searched similar keywords, locations thereof in the content and font styles thereof, and computing a second exposure point related to the advertisement data based on the result of the inspection; and computing an exposure point based on the first exposure point and the second exposure point; and an advertisement data selecting module for selecting advertisement data from the searched advertisement data.

Furthermore, according to another aspect of the present invention, the advertisement database further maintains an exception keyword related to the advertisement data, and the advertisement data selecting unit includes a keyword searching module for searching the content for an exception keyword related to the searched advertisement data and in case that the exception keyword is searched, does not adopt the searched advertisement data.

Furthermore, the present invention provides an on-line advertising method comprising the steps of: maintaining advertisement data, a keyword related thereto and a category corresponding thereto, in an advertisement database; maintaining a content identifier for identifying content provided to a user terminal through a communication network and a category related to the content, in a content database; searching the advertisement database for advertisement data corresponding to a category related to the content; selecting advertisement data from the searched advertisement data, based on a predetermined criterion, by using a keyword related to the searched advertisement data; and controlling the adopted advertisement data to be displayed on the user terminal in association with the content.

Furthermore, the present invention provides a computer readable record medium recording a program for implementing the aforementioned advertising method in a computer.

### BEST MODE FOR CARRYING OUT THE INVENTION

Hereinafter, embodiments of the present invention will be in detail described with reference to the accompanying drawings.

FIG. 2 is a drawing illustrating a network connection of an advertising system according to one embodiment of the present invention. A drawing symbol 210 indicates a web server for providing a predetermined web page for users and a drawing symbol 200 indicates an advertising system 200 for providing the web server 210 with advertisement data related to content provided through the web page. The advertising system 200 can determine a category related to the content by using a content classifying system 220, which will be described later. A user terminal 230 can be provided with the content and advertisement data by accessing to the web server 210 through a communication network.

In the meantime, although it is described in the present embodiment that the content is provided through a predetermined web page, the present invention may apply to all the content transmitted to the user terminal 230 through the wired/wireless communication network. In addition, the user terminal 230 is a concept comprising not only a PC but also a mobile communication terminal such as a cellular phone, a mobile phone, a PDA, a smart phone and the like.

Moreover, the term of ‘content’ used in the present application means digital content. It excludes advertisement data as described later, from digital content provided for users through the web page or the like. This is for the sake of convenience in explanations.

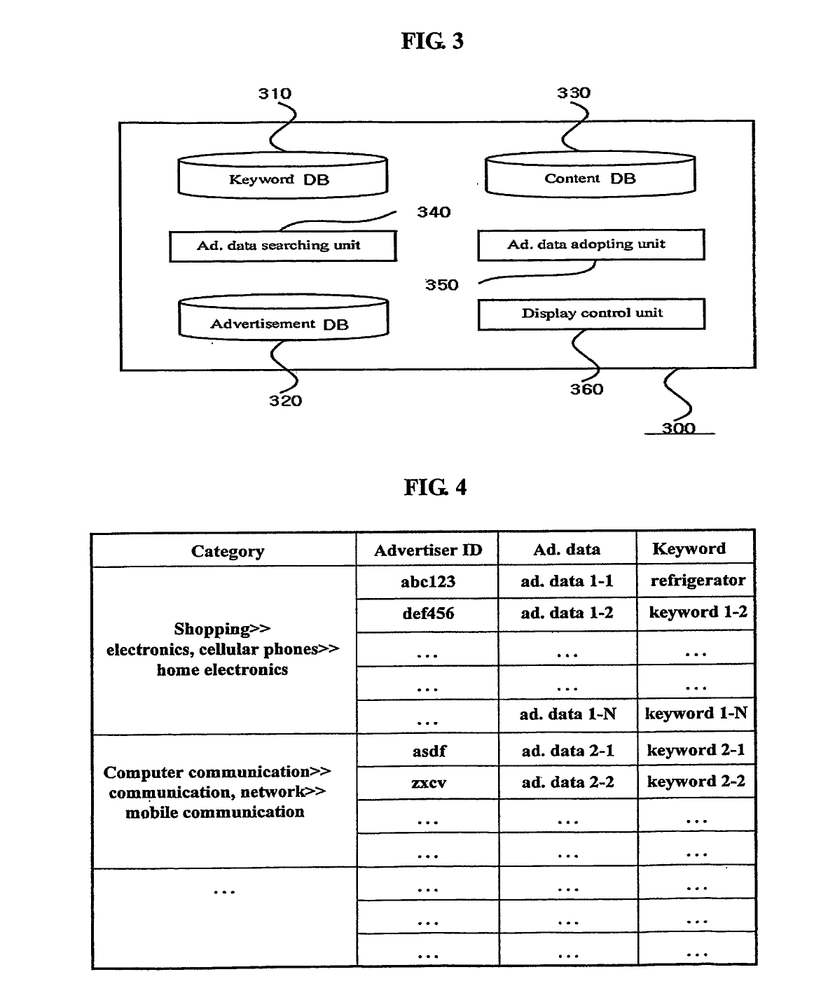

FIG. 3 is a block diagram illustrating components of an advertising system corresponding to the advertising system 200. An advertising system 300 comprises a keyword database 310, an advertisement database 320, a content database 330, an advertisement data searching unit 340, an advertisement data selecting unit 350 and a display control unit 360.

The advertisement database 320 maintains advertisement data, a keyword related thereto and a category corresponding thereto. FIG. 4 is a drawing illustrating one example of data maintained in the advertisement database 320. For example, advertisement data comprises a subject keyword with respect to goods or a service to be advertised, a URL of a site providing the goods or the service, or brief introduction with respect to the goods or the service. Hereinafter, a process for maintaining advertisement data as illustrated in FIG. 4, in the advertisement database 320 will be described.

The advertising system 300 maintains categories in a predetermined database (not illustrated) and receives a keyword and advertisement data from an advertiser through a web page for advertisements or the like. The keyword is used for determining a connection between content and advertisement data, which will be described later. The advertising system 300 provides the advertiser with a user interface enabling the same to select a category, on the web page and receives a category corresponding to the advertisement data from the advertiser. According to another embodiment of the present invention, the advertising system 300 enables the advertiser to select the category by a directory searching method or a keyword searching method.

The advertising system 300 stores and maintains advertisement data received like above, a keyword related thereto and a category corresponding thereto in the advertisement database.

The content database 330 maintains a category related to content provided through the web page. In order to maintain categories related to content in the content database 330, the advertising system 300 is required to determine a category related to the content. At this time, there may be used a method that a manager determines a predetermined category as a category related to the content by confirming details of the content. However, according to one preferred embodiment of the present invention, the advertising system 300 determines the category related to the content by classifying the content using a content classifying system.

In case that the content is a text content, the content classifying system determines the category related to the content from a text, and in case that the content is a multimedia content, the content classifying system determines the category related to the content from relevant information such as a file name of the multimedia content using predetermined classification algorithm. As for the classification algorithm, there can be used at least one of variety of algorithm such as classification algorithm which is written in “Design of a system for classifying directory-based documents of technology information documents using SVM and configuration thereof” (Yoonhee Kang, 2001 Korean Digital content Academy Vol. 2, No. 1) and the like.

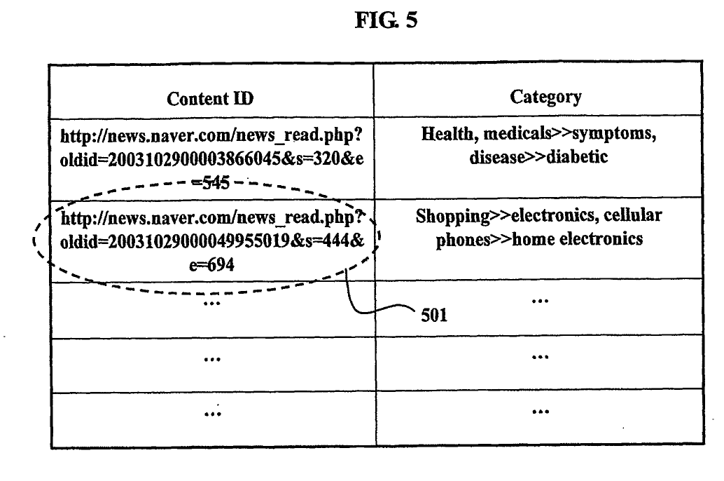

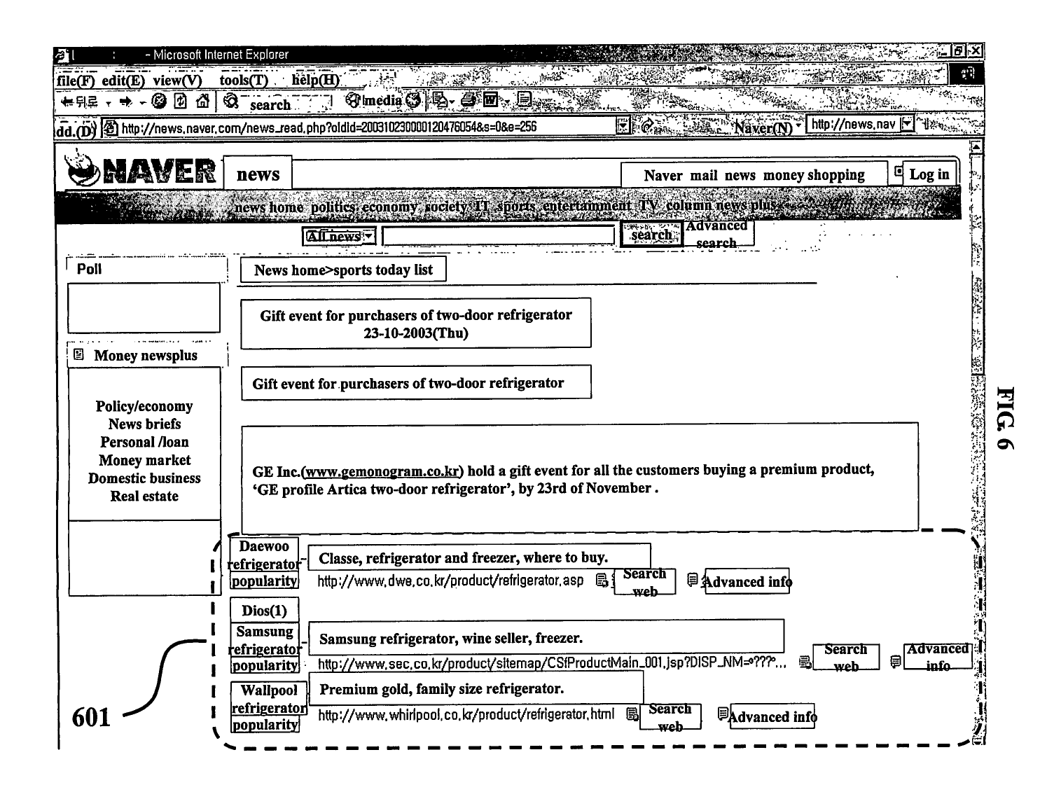

The category determined by the content classification system is stored and maintained in the content database 330, in association with the content. FIG. 5 is a drawing illustrating one example of data maintained in the content database 330. The content database 330 maintains a content identifier of predetermined content and a category related to the content. At this time, as illustrated in the figure, a URL of the web page providing the content may be used for the content identifier.

The advertisement data searching unit 340 searches the advertisement database 320 for advertisement data corresponding to the category related to the content provided on the web page. For example, in case that a content identifier provided on the web page is ‘http://news.naver.com/news_read.php?oldid=20031029000049955019&s=444 &e=694’ as indicated by a drawing symbol 501 in FIG. 5 and a category related to the content is ‘shopping>>electronics, cellular phones>>home electronics’, the advertisement data searching unit 340 searches the advertisement database 320 as illustrated in FIG. 4, for advertisement data 1-1, advertisement data 1-2 . . . and advertisement data 1-N.

The advertisement data selecting unit 350 selects advertisement data from the searched advertisement data using keywords (respectively ‘refrigerator’, keyword 1-2, . . . and keyword 1-N) related to the searched advertisement data.

The term of ‘adopted advertisement data’ used in the present specification, as described later, means advertisement data provided for the user terminal 230, in association with the advertisement data.

In case that there are too many advertisement data corresponding to one category, to display all the searched advertisement data on the web page might reduce effects of advertisements and offend a user. Therefore, it is required to adopt advertisement data to be displayed on the web page from the searched advertisement data (advertisement data 1-1, advertisement data 1-2, . . . and advertisement data 1-N).

The display control unit 360 controls the adopted advertisement data to be displayed on the web page. For example, the display control unit 360 inputs a control command enabling the adopted advertisement data to be displayed on the web page, in the web server 210. The web server 210 enables the adopted advertisement data to be displayed through the web page, by referring to the advertisement database 320. Therefore, it is possible for a user who has accessed to the web page to read the advertisement data in association with the content. FIG. 6 is a view illustrating the content displayed on the web page and advertisement data 601 adopted like above.

Like above, content and advertisement data are classified by categories and stored and only advertisement data, belonging to the same category to the category related to the content, are displayed in association with the content. Therefore, the advertising system 300 according to the present embodiment minimizes the possibility of a problem in the prior art that an advertisement unsuitable for details of content may be put on the web page.

For example, in case that the content is a news content including ‘a murderer left a dead body in the refrigerator’ and a category related to the content is ‘society and culture’, although a word of refrigerator is used in the content several times, an advertisement for selling refrigerators which belongs to the category of ‘shopping>>electronics, cellular phones>>home electronics’ is not displayed in association with the content. Namely, unlike the prior art abstracting only keywords and searching for advertisement data, according to the present embodiment managing advertisement data and contents by categories, it is secured that advertisement data suitable for details of the content are adopted and displayed.

However, as aforementioned, since it is highly possible that a plurality of advertisement data belonging to the same category exist, it is required to adopt advertisement data to substantially be displayed on the web page from advertisement data corresponding to the same category.

The advertisement data selecting unit 350 may adopt the predetermined number of advertisement data from the searched advertisement data at random.

In addition, according to another embodiment of the present invention, the advertisement data selecting unit 350 may sequentially adopt the searched advertisement data as many as the predetermined number during a predetermined period. Namely, the predetermined number (e.g., 4) of advertisement data is adopted from the searched advertisement data 1-1 to 1-N during a predetermined period (e.g., one hour). The advertisement data selecting unit 350 may repeat selecting four advertisement data sequentially during one hour, such as selecting advertisement data 1-1 to 1-4 during one hour, selecting advertisement data 1-2 to 1-5 during another one hour, and the like.

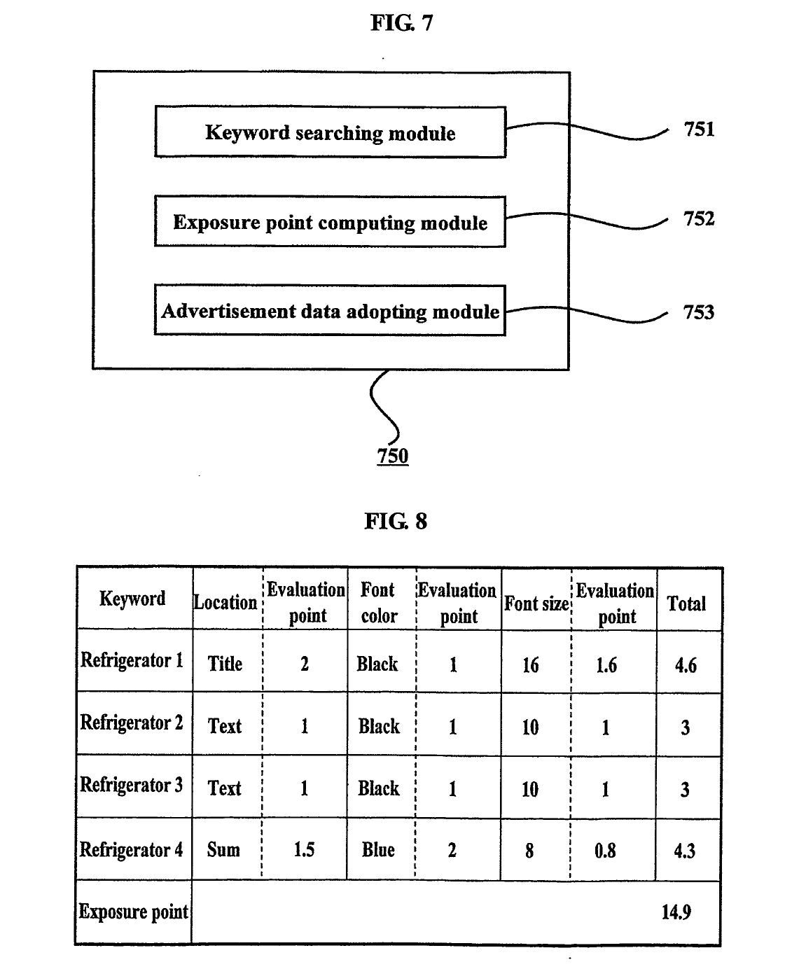

According to another embodiment of the present invention, the advertising system 300 provides the advertisement data selecting unit 350 which can adopt advertisement data, the most relevant to details of the content. FIG. 7 is a block diagram illustrating an advertisement data selecting unit 750 corresponding to the advertisement data selecting unit according to the present embodiment. The advertisement data selecting unit 750 comprises a keyword searching module 751, an exposure point computing module 752 and an advertisement data selecting module 753.

The keyword searching module 751 searches the content for a keyword related to the searched advertisement data. As aforementioned, in case that a category related to the content is ‘shopping>>electronics, cellular phones>>home electronics’ and advertisement data 1-1, advertisement data 1-2, . . . and advertisement data 1-N are searched as for advertisement data corresponding to the category, keywords related to each advertisement data are respectively ‘refrigerator’ keyword 1-2, . . . and keyword 1-N.

The keyword searching module 751 searches the content for words of ‘refrigerator’, keyword 1-2, . . . and keyword 1-N respectively. In case that the content is a multimedia content such as video data or audio data, not text data, the keyword searching module 751 searches relevant text data such as a file name related to the multimedia content or text information included in corresponding multimedia data, for keywords.

The exposure point computing module 752 computes an exposure point related to each of advertisement data using the searched keywords. At this time, the exposure point computing module 752 inspects the number of searched keywords, locations thereof in the content, font styles thereof, and the like, in order to compute an exposure point.

In case that the content is divided according to a predetermined classification method such as a title, text, summary and the like, the exposure point computing module 752 computes an exposure point, based on the location where the keyword is located among the title, text, or summary.

Furthermore, the exposure point computing module 752 computes an exposure point for the keyword, based on a font style thereof, i.e. the font size thereof, the font color there of and the like.

Furthermore, the exposure point computing module 752 may compute an exposure point, by collectively considering the number of the keywords, location of each of searched keywords, font styles thereof and the like.

For example, the exposure point computing module 752 computes an exposure point related to advertisement data 1-1 by using keyword ‘refrigerator’ related thereto, as illustrated in FIG. 8. In case that the content provided on the web page is i) identifiable by a title, a text and a summary, ii) the text provided on the web page is set mainly by black and iii) the font size of the text provided on the web pate is mainly 10, the exposure point computing module 752 can compute an exposure point as illustrated in FIG. 8. In FIG. 8, there is used a method of computing an exposure point by computing an evaluation point according to the location or the font style and adding up the same. That is, an exposure point related to advertisement data 1-1 is 14.9.

Namely, the exposure point computing module 752 further reflects a keyword located in the summary rather than one in the text and one located in the title rather than one in the summary, in an exposure point, and further reflects a keyword having a different font color from other texts in an exposure point, and further reflects a keyword having a larger font color than other texts, in an exposure point.

Similarly, the exposure point computing module 752 respectively computes an exposure point with respect to advertisement data 1-2, advertisement data 1-3, . . . and advertisement data 1-N.

The advertisement data selecting module 753 selects advertisement data from the advertisement data by using an exposure point computed by advertisement data like above. For example, the advertisement data selecting module 753 may adopt four advertisement data in order which an exposure point thereof ranks high, as illustrated in FIG. 6.

Furthermore, even in case that only four advertisement data are displayed on the web page, the advertisement data selecting module 753 selects ten advertisement data in order which an exposure point thereof ranks high, and sequentially selects four advertisement data from the ten selected advertisement data during a predetermined period. For example, in case that ten advertisement data such as advertisement data 1-1, advertisement data 1-2, . . . , and advertisement data 1-10 are selected, the advertisement data selecting module 753 repeats selecting advertisement data sequentially in a way of selecting advertisement data 1-1 to 1-4 during a predetermined period (e.g., one hour) and after one hour, selecting advertisement data 1-5 to 1-8 during another one hour. In addition, the advertisement data selecting module 753 may repeat selecting random four from advertisement data corresponding to top ten which an exposure point thereof ranks, during a predetermined period, and also, while repeating selecting random four advertisement data during a predetermined period, may enable each of advertisement data to be generally adopted during the simultaneous time.

The term of ‘selected advertisement data’ used in the present specification is advertisement data satisfying a predetermined criterion among advertisement data searched by the advertisement data searching unit 340. Therefore, in an embodiment including a process of selecting advertisement data, the advertisement data selecting unit 350 selects advertisement data from the selected advertisement data.

In the meantime, in case that an exposure point is computed in a method like above, there is no doubt that the more the number of keywords is included in the content, the bigger the exposure point is computed.

A process of computing an exposure index using specific numbers is described in the present embodiment. However, the scope of the present invention is not limited thereto. It will be apparent that configuration of computing an exposure point using the number of keywords, locations thereof in content and font styles thereof is within the scope of the present invention.

Furthermore, according to another embodiment of the present invention, the advertisement data selecting unit 350 secures a connection between the content and adopted advertisement data more positively, by computing an exposure point using a relevant keyword related to the keyword as well as a keyword related to advertisement data.

Hereinafter, an event of computing an exposure point using a keyword and a relevant keyword will be described.

The keyword database 310 maintains a keyword and a relevant keyword related thereto. The relevant keyword comprises a similar keyword or an expansion keyword. The similar keyword is a keyword having a similar meaning to the meaning of the keyword. The expansion keyword is a keyword having the meaning of an upper concept of the meaning of the keyword or a lower concept thereof. For example, in case that a keyword is ‘inline’, ‘inline’ can be selected as a similar keyword and ‘skate’, ‘leisure’, and the like can be selected as an expansion keyword. In the present embodiment, a similar keyword and an expansion keyword will be used for a relevant keyword.

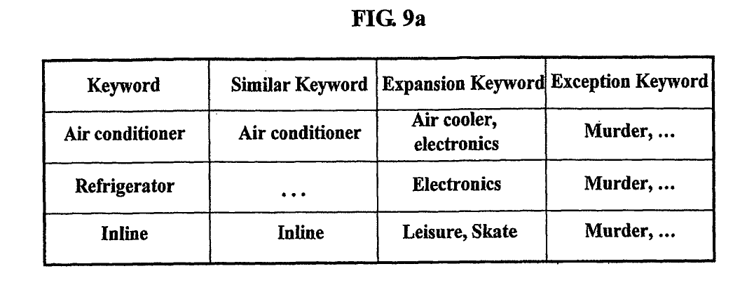

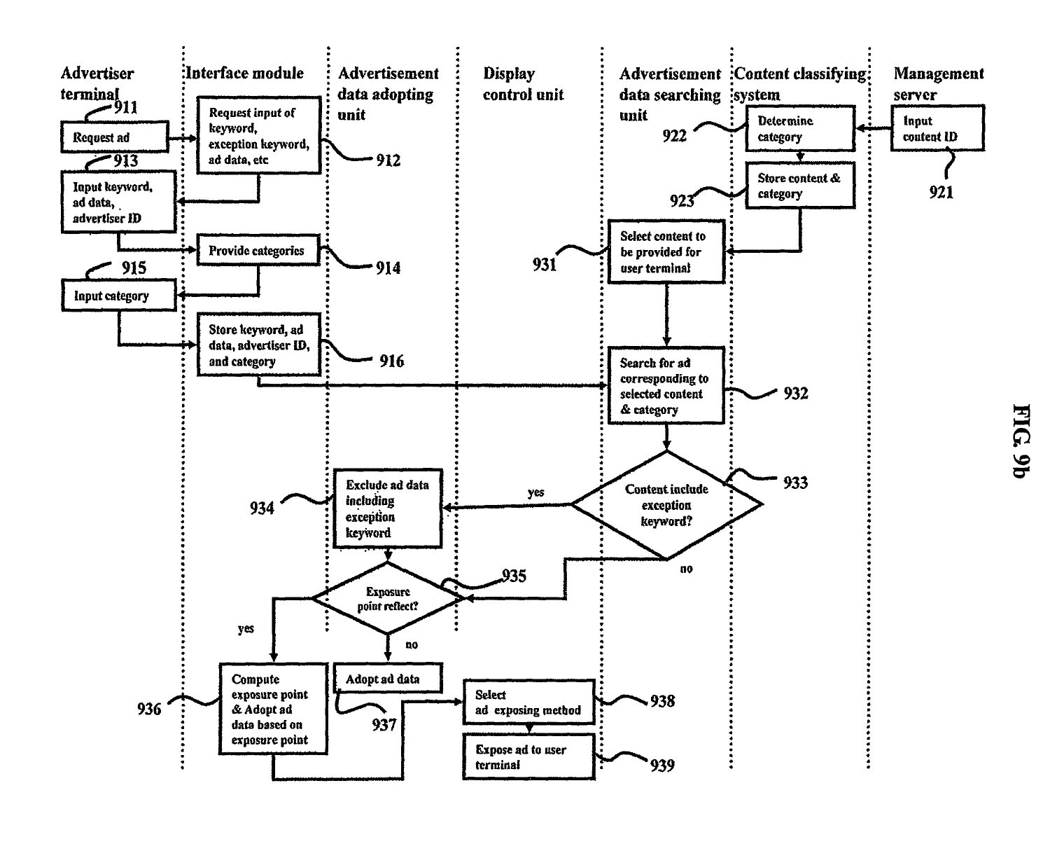

FIG. 9a is a drawing illustrating one example of a keyword, a similar keyword related thereto, and an expansion keyword related thereto maintained in the keyword database 310. FIG. 9a illustrates an event of maintaining an exception keyword related to a keyword. Configuration related to the exception keyword will be described later.

The keyword searching module 751 searches the content for a keyword related to the searched advertisement data and a relevant keyword related thereto.

The exposure point computing module 752 respectively computes exposure points from the searched keyword, the searched similar keyword and the searched expansion keyword (a first exposure point, a second exposure and a third exposure point in order). The first to third exposure points from the keyword, the similar keyword, and the expansion keyword can be computed by a similar method to the aforementioned method. For example, in case that the keyword is ‘refrigerator’, a first exposure point is 14.9. As illustrated in FIG. 9a, in case that there is no selected keyword as a similar keyword to ‘refrigerator’, a second exposure point is 0. In addition, it is possible to compute a third exposure point with respect to ‘electronics’, i.e. an expansion keyword, in a similar method as aforementioned using FIG. 8. For example, two keywords of ‘electronics’ are included in the content (in order to identify two keywords, respectively electronics 1 and electronics 2), electronics 1 is located in a title, the font color thereof is black, and the font size thereof is 16, an evaluation point related to electronics 1 is 1×2+1×1+1×1.6=4.6. An evaluation point related to electronics 2 is 4. At this time, the third exposure point is 4.6+4=8.6.

It is preferred that the exposure point computing module 752 computes an exposure point from first to third exposure points, and gives weight of 1 to a keyword, weight of 0.8 to a similar keyword and weight of 0.5 to an expansion keyword. Namely, the exposure point is computed as 14.9×1+0×0.8+8.6×0.5=19.2.

The exposure point computing module 752 computes an exposure point related to advertisement data by using a keyword, a similar keyword and an expansion keyword, in the aforementioned method. At this time, the advertisement data selecting module 753 can adopt advertisement data based on the exposure point. Like above, an exposure point related to advertisement data is computed by further using a relevant keyword such as a similar keyword or an expansion keyword, not to mention a keyword, and advertisement data is adopted based on the exposure point. Therefore, according to the present embodiment, advertisement data whose connection with content provided through the web page is guaranteed is put on the web page. Therefore, since it is general that users often access to a web page providing contents in which they are interested, an advertising system enabling user targeting is provided.

Moreover, according to another embodiment of the present invention, the keyword database 310 further maintains an exception keyword related to a keyword, as illustrated in FIG. 9a.

The keyword searching module 751 searches the content for an exception keyword related to the searched advertisement data.

According to another embodiment of the present invention, a keyword such as ‘murder’, ‘rape’, or the like may be selected as an exception keyword regardless of the keyword (or related to all the keywords). Namely, in case that the keyword of ‘murder’ is comprised in the content, advertisement data is not put on the web page. However, in case that the content is a news content delivering an accident including a keyword such as ‘murder’, ‘rape’, or the like, and in case that an advertisement for security equipments or security service of a security company is put on the web page, it is possible to expect the effect of the advertisement. Therefore, the exception keyword can be maintained in association with each of keywords respectively.

FIG. 9b is a flowchart for generally describing a process performed by each module of the advertising system 300 according to the present embodiment. The advertising system 300 further comprises a predetermined interface module (not illustrated) and a category database maintaining categories (not illustrated).

In case that a request for advertisement is input from an advertiser terminal (not illustrated) through a communication network in step 911, the interface module requires the advertiser terminal that predetermined information including advertisement data be input in step 912.

In case that information such as a keyword, advertisement data, an advertiser identifier, or the like is input from the advertiser terminal in step 913, the interface module provides the advertiser with a list of categories maintained in the category database in step 914.

The advertiser inputs selection of a category that is considered to be related to advertisement data, based on the provided list of categories, in step 915.

The advertisement database 320 is embodied by maintaining the input keyword, advertisement data, advertiser identifier, or the like therein in association with the selected category, in step 916.

Furthermore, in case that a content identifier is input from a predetermined management server (not illustrated) in step 921, the content classifying system 220 identifies a predetermined content based on the content identifier, and determines a category related to the content by using a keyword or the like comprised in the content, in step 922. The content classifying system 220 embodies the content database 330 by storing a content identifier and a category determined like above in the content database 330 in association with the content identifier, in step 923.

In case that a content to be provided for the user terminal 230 by a user's request is selected in step 931, the advertisement data searching unit 340 searches the content database 330 for a category related to the selected content and searches the advertisement database 320 for advertisement data related to the searched category, in step 932.

In case of selecting advertisement data by using an exposure point of result, the advertisement data selecting unit 350 computes an exposure point related to a keyword in step 934 and selects predetermined advertisement data from the searched advertisement data based on the exposure point, in step 935. A method of computing an exposure point using a keyword or a relevant keyword and a method of selecting advertisement data based on the exposure point have been in detail described.

The display control unit 360 determines a method of displaying advertisement data adopted like above, in step 936. For example, according to another embodiment of the present invention, there may be used a display method enabling predetermined advertisement data to be more outstanding than other advertisement data according to a billing system.

Moreover, the display control unit 360 enables the adopted advertisement data to be exposed in the user terminal 230 according to a display method determined like above, in step 937.

In case of selecting advertisement data without using an exposure point, there is no need to perform a procedure of computing an exposure point. At this time, there may be used an selecting method such as a method of displaying the searched advertisement data in a rolling method or the like.

Advertisement data related to a predetermined content is provided to a user through the procedures like above.

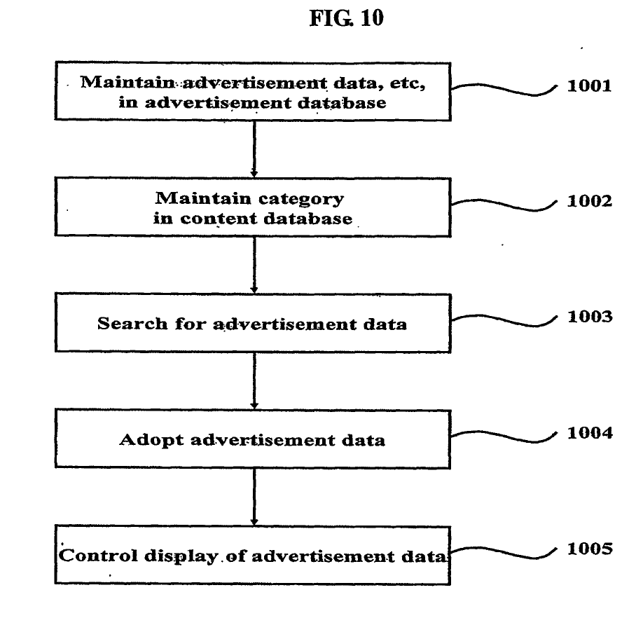

Hereinafter, an on-line advertising method according to another embodiment of the present invention will be described. FIG. 10 is a flowchart illustrating an on-line advertising method according to the present embodiment.

As illustrated in FIG. 4, advertisement data, a keyword related thereto and a category related thereto are maintained in an advertisement database in step 1001.

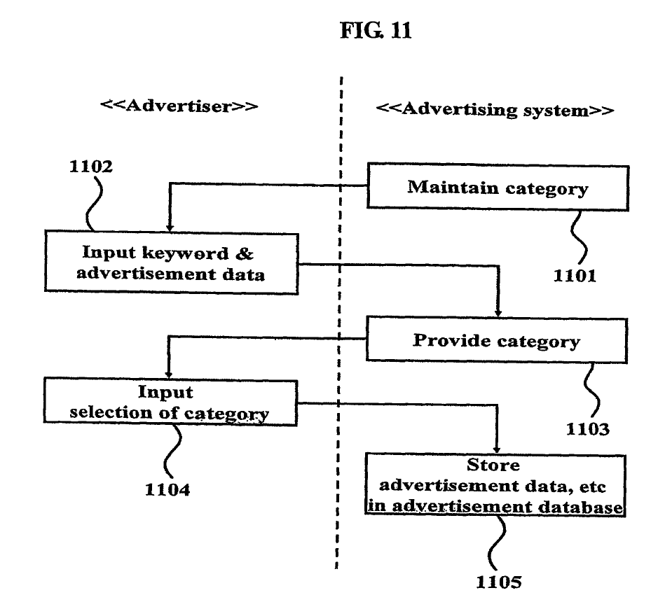

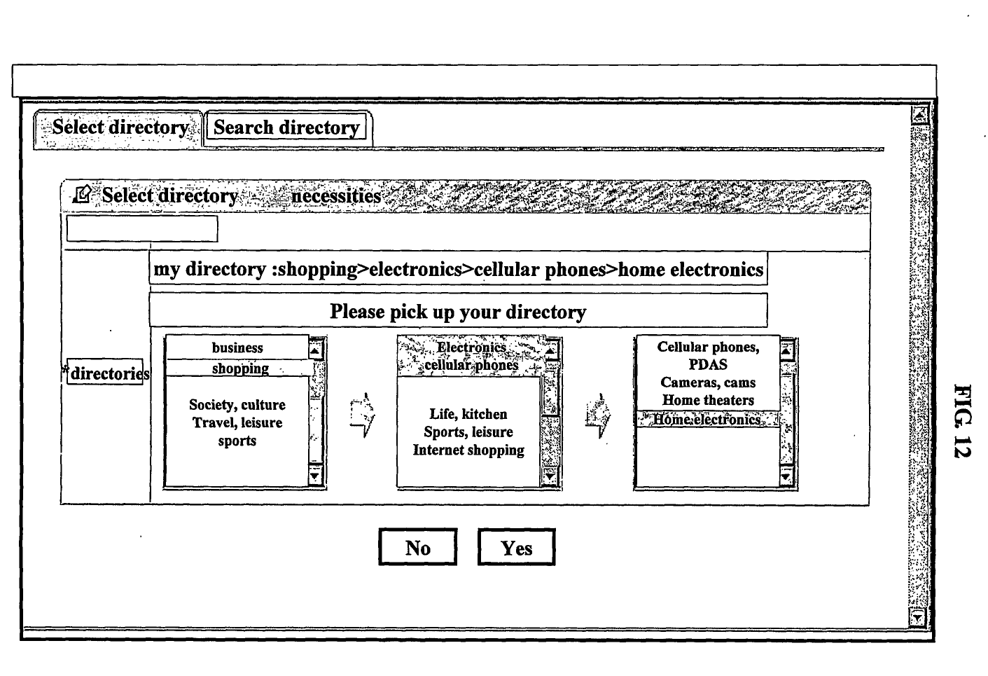

FIG. 11 is a flowchart more specifically illustrating procedures of maintaining the advertisement database of step 1001. A category is maintained in a predetermined database in step 1101. The category may be maintained to have at least one depth according to inclusive relation, so that a user may easily select a category what the user wants, which will be described later. For example, ‘shopping>>electronics, cellular phones>>home electronics’ category has three depths such as ‘shopping (electronics, cellular phones (home electronics.

A keyword and advertisement data are input from the advertiser in step 1102. The advertiser selects at least one keyword which is considered to be most relevant to goods or service that the advertiser wants to advertise, and inputs the keyword in association with the advertisement data. It is also possible to predetermine the number of keywords enabled to be input according to embodiments.

A list of categories is provided for the advertiser in step 1103. For example, categories maintained in the category database may be provided for the advertiser by a directory searching method. In addition, in case that a keyword related to the category is further maintained in the category database and a predetermined keyword is input from the user, there may be used a keyword searching method which searches for a category related to the input keyword and provides the searched category for the advertiser.

Selection of a category among categories provided for the advertiser is input from the advertiser in step 1104. FIG. 12 is a drawing illustrating one example of an interface enabling the advertiser to select a category by a directory searching method.

In step 1105, the input keyword is stored in the advertisement database, in association with the advertisement data and the selected category is stored in the advertisement database, in correspondence to the advertisement data.

Through steps 1101 to 1105 like above, advertisement data, a keyword related thereto and a category corresponding thereto are maintained in the advertisement database.

In step 1002, a category related to content provided through a predetermined web page is maintained in the contents database. In order to determine a category related to the content, there may be used variety of methods such as the document classifying method written in the aforementioned treatise, and the like.

Advertisement data corresponding to a category related to the content is searched from the advertisement database in step 1003, and advertisement data is adopted from the searched advertisement data by using a keyword related thereto, based on a predetermined criterion, in step 1004.

In case that there are too may advertisement data corresponding to the same category and all the advertisement data are displayed on the web page in step 1005, the effect of advertisement might be reduced by offending a user who has accessed to the web page and decreasing the user's concentration with respect to each of advertisement data. Therefore, it is required to adopt the proper number of advertisement data in association with the content.

At this time, in step 1004, it is possible to select the predetermined number of random advertisement data from the searched advertisement data without using the keyword. However, advertisement data can be embodied to be adopted by using a keyword related to each of advertisement data so that advertisement data which is highly relevant to details of the content may be adopted in association with the content.

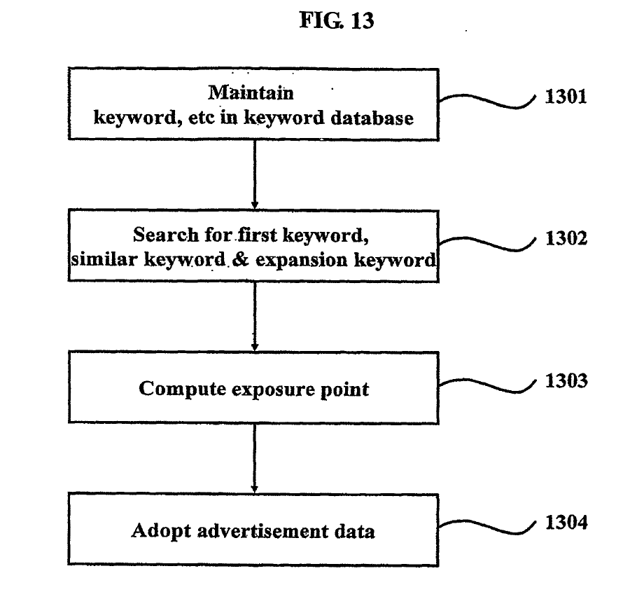

FIG. 13 is a flowchart more specifically illustrating procedures of selecting advertisement data by using the keyword in step 1004. In step 1301, a keyword, a similar keyword related thereto and an expansion keyword related thereto are maintained in a keyword database. The similar keyword is a keyword having an equivalent meaning to the keyword (e.g., in case that a keyword is ‘inline’, ‘inline’ is a similar keyword), and the expansion keyword is a keyword having a meaning of a upper concept of the meaning of the keyword or a lower concept thereof (e.g., in case that a keyword is ‘inline’, ‘leisure’ is an expansion keyword having a upper concept. At least one of the keyword, the similar keyword or the expansion keyword can be maintained in association with each of advertisement data.

In step 1302, a keyword related to advertisement data searched in step 1003 (hereinafter, a first keyword), a similar keyword related to the first keyword and an expansion keyword related thereto are respectively searched from the content.

In step 1303, an exposure point related to the searched advertisement data is computed. A first exposure point related to the first keyword is computed on the basis of a location of the searched first keyword and a font style (including a font color or a font size) thereof. At this time, in case that the number of searched first keywords is plural, exposure points related to each of first keywords are computed and added up, whereby a first exposure point related to the first keyword can be computed. At this time, since the first exposure point is computed by adding up computed exposure points with respect to each of searched first keywords, the more the number of first keywords, the higher the first exposure point. Thus, the number of the first keywords is also reflected in the first exposure point. A method of computing an exposure point related to the keyword using a location thereof and a font style thereof has been described in the aforementioned embodiment. Therefore, the same will be omitted in the present embodiment.

A second exposure point with respect to a similar keyword related to the first keyword or a third exposure point with respect to an expansion keyword related thereto can be computed respectively by a similar method.

The total exposure point related to the advertisement data can be computed using the first to third exposure points. At this time, the exposure point related to each of the searched advertisement data can be computed by giving predetermined weight to the first to third exposure points.

Advertisement data is adopted from the searched advertisement data, based on the exposure point computed like above in step 1305, and the adopted advertisement data is controlled to be displayed on the web page in step 1005.

In order to adopt the advertisement data, there may be used variety of methods such as a method of selecting the predetermined number of corresponding advertisement data in order which the exposure point thereof ranks high, a method of selecting the predetermined number of advertisement data from selected advertisement data in order during the certain time, after selecting the predetermined number of advertisement data in order which the exposure point thereof ranks high, and the like.

According to the present embodiment, it is possible to adopt and display advertisement data in association with a content of which category is matched. Thus, there is no event of the problem in the prior art, such as offending a user by putting an advertisement in association with the content. Moreover, since advertisement data to be displayed on the web page is adopted by using a keyword related to each of advertisement data, it is possible to adopt advertisement data which is secured to have a connection with the content provided on the web page.

In addition, the present invention provides computer readable record media recording a program for implementing the aforementioned advertising method in a computer. The media may also include, alone or in combination with the program instructions, data files, data structures, tables, and the like. The media and program instructions may be those specially designed and constructed for the purposes of the present invention, or they may be of the kind well known and available to those skilled in the computer software arts.

### INDUSTRIAL APPLICABILITY

According to the present invention, there is provided an on-line advertising system and method which can secure a connection between content and an advertisement provided for users through a wired/wireless communication network, related to the content.

Moreover, although an advertisement is highly connected to content provided for users through a wired/wireless communication network, in case that it is determined that the advertisement is irrelevant based on goods to be sold through the advertisement or a service image, according to the present invention, there is provided an on-line advertising system and method which can prohibit the advertisement from being put on the web page together with the content.

Like above, although the present invention has been described in association with the embodiment of the present invention illustrated in the accompanying drawings, it is not limited thereto since it will be apparent to those skilled in the art that various substitutions, modifications and changes may be made thereto without departing from the scope and spirit of the invention.

What is claimed is:

1. An on-line advertising system, comprising:
an advertisement database for maintaining advertisement data of a plurality of advertisements, a keyword related to each said advertisement and a category corresponding to each said advertisement;
a content database for maintaining a content identifier for identifying content provided to a user terminal through a communication network, and a category related to the content;
an advertisement data searching unit for searching the advertisement database for advertisement data corresponding to a category related to the content to be searched;
an advertisement data selecting unit for selecting a portion of advertisement data among the searched advertisement data, based on a predetermined criterion, by using a keyword related to the searched advertisement data; and
a display control unit for controlling the selected advertisement data to be displayed on the user terminal in association with the searched content.

2. The system as claimed in claim 1, wherein the advertisement data selecting unit comprises:
a keyword searching module for searching the content for a keyword related to the searched advertisement data;
an exposure point computing module for inspecting at least one selected from a group consisting of the number of the searched keywords, locations thereof in the content and a font style thereof, and computing an exposure point related to the advertisement data based on the result of the inspection; and
an advertisement data selecting module for selecting a portion of advertisement data among the searched advertisement data, based on the exposure point.

3. The system as claimed in claim 1, the system further comprising a keyword database for maintaining a keyword and a similar keyword related thereto, wherein the similar keyword is a keyword having a similar meaning to the meaning of the keyword;
wherein the advertisement data selecting unit comprises:
a keyword searching module for searching the content for a keyword related to the searched advertisement data and a similar keyword to the keyword;
an exposure point computing module for inspecting at least one selected from a group consisting of the number of the searched similar keywords, locations thereof in the content and a font style thereof, and computing an exposure point related to the advertisement data based on the result of the inspection; and
an advertisement data selecting module for selecting a portion of advertisement data from the searched advertisement data, based on the exposure point.

4. The system as claimed in claim 1, the system further comprising a keyword database for maintaining a keyword and an expansion keyword related thereto, wherein the expansion keyword is a keyword having a meaning of a upper concept of the meaning of the keyword or a lower concept thereof;
wherein the advertisement data selecting unit comprises:
a keyword searching module for searching the content for a keyword related to the searched advertisement data and an expansion keyword related to the keyword;
an exposure point computing module for inspecting at least one selected from a group consisting of the number of the searched expansion keywords, locations thereof in the content and a font style thereof, and computing an exposure point related to the advertisement data based on the result of the inspection; and
an advertisement data selecting module for selecting a portion of advertisement data from the searched advertisement data, based on the exposure point.

5. The system as claimed in claim 1, the system further comprising a keyword database for maintaining a keyword, a similar keyword related thereto and an expansion keyword related thereto, wherein the similar keyword is a keyword having a similar meaning to the meaning of the keyword and the expansion keyword is a keyword having a meaning of a upper concept of the meaning of the keyword or a lower concept thereof;
wherein the advertisement data selecting unit comprises:
a keyword searching module for searching the content for a keyword related to the searched advertisement data, a similar keyword related to the keyword and an expansion keyword related thereto;
an exposure point computing module for inspecting at least one selected from a group consisting of the number of the searched keywords, locations thereof in the content and a font style thereof, and computing a first exposure point related to the advertisement data based on the result of the inspection;
inspecting at least one selected from a group consisting of the number of the searched similar keywords, locations thereof in the content and a font style thereof, and computing a second exposure point related to the advertisement data based on the result of the inspection;
inspecting at least one selected from a group consisting of the number of the searched expansion keywords, locations thereof in the content and a font style thereof, computing a third exposure point related to the advertisement data based on the result of the inspection; and
computing an exposure point based on at least one of the first exposure point, the second exposure point and the third exposure point; and
an advertisement data selecting module for selecting a portion of advertisement data from the searched advertisement data, based on the exposure point.

6. The system as claimed in claim 5, wherein the exposure point computing module computes the exposure point by giving a weight to the first exposure point, the second exposure point or the third exposure point.

7. The system as claimed in claim 2, wherein the advertisement data selecting module selects the predetermined number of advertisement data of which the exposure point ranks high.

8. The system as claimed in claim 2, wherein the advertisement data selecting module selects predetermined advertisement data from the searched advertisement data on the basis of the exposure point and selects a predetermined number of random advertisement data, during a predetermined period, from the selected advertisement data.

9. The system as claimed in claim 8, wherein the advertisement data selecting module sequentially selects a predetermined number of the selected advertisement data during the predetermined period.

10. The system as claimed in claim 1, wherein the advertisement data selecting unit selects a predetermined number of random advertisement data from the searched advertisement data.

11. The system as claimed in claim 1, wherein the advertisement data selecting unit sequentially selects the predetermined number of advertisement data during a predetermined period from the searched advertisement data.

12. An on-line advertising method, the method comprising the steps of:
maintaining advertisement data, a keyword related thereto and a category corresponding thereto, in an advertisement database;
maintaining a content identifier for identifying content provided to a user terminal through a communication network and a category related to the content, in a content database;
searching the advertisement database for advertisement data corresponding to a category related to the content;
selecting advertisement data from the searched advertisement data, based on a predetermined criterion, by using a keyword related to the searched advertisement data; and
controlling the adopted advertisement data to be displayed on the user terminal in association with the content.

13. The method as claimed in claim 12, wherein the step of maintaining the advertisement database comprises the steps of:
receiving a keyword and advertisement data from an advertiser;
receiving selection of a category from the advertiser; and
storing the received keyword in the advertisement database, in association with the advertisement data and storing the selected category in the advertisement database, in correspondence with the advertisement data.

14. The method as claimed in claim 13, wherein the step of receiving selection of a category from the advertiser comprises the steps of:
maintaining categories in a predetermined database;
providing the categories for the advertiser by a directory searching method; and
receiving selection of a predetermined category among the provided categories, from the advertiser.

15. The method as claimed in claim 12, the method further comprising the step of maintaining keywords in a keyword database;
wherein the step of selecting advertisement data according to a predetermined criterion from the searched advertisement data by using the keyword comprises the steps of:
respectively searching the content for a keyword related to the advertisement data;
inspecting at least one selected from a group consisting of the number of the searched keywords, locations thereof in the content and a font style thereof, and computing an exposure point related to the searched advertisement data based on the result of the inspection; and
selecting advertisement data from the searched advertisement data based on the exposure point.

16. The method as claimed in claim 12, the method further comprising the step of maintaining a keyword, a similar keyword related thereto or an expansion keyword related thereto in a keyword database, wherein the similar keyword is a keyword having a similar meaning to the meaning of the keyword and the expansion keyword is a keyword having a meaning of a upper concept of the meaning of the keyword or a lower concept thereof;
wherein the step of selecting advertisement data according to a predetermined criterion from the searched advertisement data using the keyword comprises the steps of:
respectively searching the content for a keyword related to the advertisement data;
searching for a similar keyword related to the searched keyword or an expansion keyword related thereto;
inspecting at least one selected from a group consisting of the number of the searched similar keywords, locations thereof in the content and a font style thereof, and computing a first exposure point related to the advertisement data based on the result of the inspection;
inspecting at least one selected from a group consisting of the number of the searched expansion keywords, locations thereof in the content and a font style thereof, and computing a second exposure point related to the advertisement data based on the result of the inspection; and
computing an exposure point from the searched advertisement data, based on the first exposure point or the second exposure point.

17. A computer readable record medium recording a program for implementing an on-line advertising method, the method comprising the steps of:
maintaining advertisement data, a keyword related thereto and a category corresponding thereto, in an advertisement database;
maintaining a content identifier for identifying content provided to a user terminal through a communication network and a category related to the content, in a content database;
searching the advertisement database for advertisement data corresponding to a category related to the content;
selecting advertisement data from the searched advertisement data, based on a predetermined criterion, by using a keyword related to the searched advertisement data; and
controlling the adopted advertisement data to be displayed on the user terminal in association with the content.
